(19) United States
(12) Patent Application Publication
(10) Pub. No.: US 2024/0190370 A1
(43) Pub. Date: Jun. 13, 2024

(54) WIRELESS RAMP COMMUNICATION SYSTEM

(71) Applicant: The Braun Corporation, Winamac, IN (US)

(72) Inventor: Michael Alexander, West Lafayett, IN (US)

(21) Appl. No.: 18/536,470

(22) Filed: Dec. 12, 2023

Related U.S. Application Data
(60) Provisional application No. 63/432,133, filed on Dec. 13, 2022.

(51) Int. Cl. B60R 16/033; A61G 3/06; B60P 1/43; H02J 50/10

(52) U.S. Cl. CPC B60R 16/033; A61G 3/061; B60P 1/431; H02J 50/10

(57) ABSTRACT

A ramp assembly is provided for use to accommodate a wheel-chaired passenger to enter or exit a motorized vehicle. The ramp assembly includes a ramp platform movably coupled to a ramp housing, a first controller configured to control movement of the ramp platform between a first position and a second position, and a second controller coupled to the ramp platform. The second controller is in electrical communication with the first controller. A first inductive charger is coupled to the ramp housing and disposed in electrical communication with the first controller, and a second inductive charger is electrically coupled to the second controller. In the first position, the first inductive charger is electrically coupled to second inductive charger to provide electrical power to the second controller. In the second position, the first inductive charge is electrically decoupled from the second inductive charger.

### CROSS REFERENCE TO OTHER APPLICATIONS

This application claims priority to U.S. Provisional Patent Application No. 63/432,133, filed on Dec. 13, 2022, which is incorporated herein by reference. This application also incorporates by reference PCT Application No. PCT/US23/83487, filed on Dec. 12, 2023.

### FIELD OF THE DISCLOSURE

The present application relates to a passenger vehicle for transporting one or more passengers, and more particularly to a ramp assembly with a communication capability.

### BACKGROUND

Automobile manufacturers do not currently mass-produce passenger motor vehicles specifically designed to transport passengers having physical limitations, either as a driver or as a non-driving passenger. Consequently, mass-produced passenger vehicles are modified, or retrofitted, by a number of aftermarket companies dedicated to supplying vehicles to physically limited passengers. Such vehicles can be modified by removing certain parts or structures within a vehicle and replacing those parts with parts specifically designed to accommodate the physically limited passenger. For example, in one configuration, a van or bus is retrofitted with a ramp to enable a physically limited individual using a wheelchair to enter and exit the vehicle without the assistance of another individual.

Other known products for retrofitting a vehicle, such as a van, bus, sport-utility vehicle, or motor coach, include wheel chair lifts, lift platforms, and lowered floor surfaces. In some instances, a floor of an original equipment manufacturer (OEM) vehicle is lowered or otherwise modified to accommodate an entry and exit of the physically limited individual through a side door or entrance of the vehicle. Once inside the vehicle, an individual who uses the assisted entrance may be located in a rear passenger compartment of the vehicle adjacent to or behind the side entrance.

### SUMMARY OF THE EMBODIMENTS

In a first embodiment of this disclosure a ramp assembly for use to accommodate a wheel-chaired passenger to enter or exit a motorized vehicle, includes a ramp platform having a length defined along a longitudinal direction; a ramp housing coupled to the ramp platform; a main controller located on a fixed position of the ramp assembly or on the vehicle; a power source coupled to the main controller; a transmitting inductive charger coupled to the ramp housing; a secondary controller coupled to the ramp platform; a battery coupled to the secondary controller; a receiving inductive charger coupled to the battery of the secondary controller; wherein the ramp platform moves between a stowed position and a deployed position; further wherein the transmitting inductive charger receives power from the power source through the main controller; further wherein the main controller controls the logic of the ramp platform by wirelessly communicating with the secondary controller; further wherein the secondary controller wirelessly provides data to the main controller and wirelessly receives input from the main controller; further wherein the transmitting inductive charger charges the battery of the secondary controller through the receiving inductive charger when the ramp platform is in the stowed position; and further wherein the battery of the secondary controller at least partially powers the secondary controller when the ramp platform is in the deployed position.

In one embodiment, the ramp assembly used to accommodate a wheelchaired passenger to enter and exit a motorized vehicle further includes a daughter board coupled to the main controller; wherein the daughter board provides input to and receives input from the main controller; further wherein the daughter board wirelessly provides input to and receives input from the secondary controller. In another embodiment, the ramp assembly further includes one or more interlocks. The ramp assembly may also include one or more ramp operation buttons, wherein the one or more ramp operation buttons signal the ramp platform to move into a deployed position or a stowed position, or to stop movement of the ramp platform. In one embodiment, the ramp assembly may further include one or more sensors; wherein the one or more sensors provide an indication if an indication event is detected; and further wherein the one or more sensors wirelessly communicate. In this embodiment the one or more sensors is at least partially powered by the battery coupled to the secondary controller when the ramp platform is in a deployed position In one embodiment the ramp assembly may further comprise one or more lights coupled to the ramp platform. In this embodiment, one or more lights is at least partially powered by the battery coupled to the secondary controller when the ramp platform is in a deployed position.

In a further embodiment of the present disclosure, a motorized vehicle includes a chassis; a floor structure formed in the chassis, the floor structure defining an inner compartment; a ramp assembly movable between a stowed position in which the ramp assembly is disposed in the compartment and a deployed position wherein the ramp assembly is not fully disposed in the compartment, the ramp assembly comprising a ramp platform coupled to the vehicle, a ramp housing coupled to the ramp platform, a main controller, a power source coupled to the main controller, a transmitting inductive charger coupled to the ramp housing and to the main controller, a receiving inductive charger coupled to the ramp platform, a secondary controller coupled to the ramp platform, and a battery coupled to the secondary controller and the receiving inductive charger; wherein the transmitting inductive charger receives power from the power source; further wherein the main controller controls the logic of the ramp platform by wirelessly communicating with the secondary controller; further wherein the secondary controller wirelessly provides data to the main controller and wirelessly receives input from the main controller; further wherein the transmitting inductive charger charges the secondary controller battery through the receiving inductive charger when the ramp platform is in the stowed position; and further wherein the secondary controller battery at least partially powers the secondary controller when the ramp platform is in the deployed position.

In one example of this embodiment, the vehicle further includes a daughter board coupled to the main controller; wherein the daughter board communicates with the main controller; further wherein the daughter board communicates wirelessly with the secondary controller. The vehicle may further include one or more interlocks. The vehicle further may include a ramp operation button. In one example of this embodiment, the vehicle also includes one or more sensors coupled to the ramp platform and one or more lights coupled to the ramp platform; wherein the one or more sensors communicate audibly or visually if an indication event is detected. The one or more sensors of the vehicle may include at least one of a platform sensor, an obstacle detection sensor, a slope sensor, and an acceleration sensor. The one or more sensors and the one or more lights may be at least partially powered by the battery to the secondary controller when the ramp platform is in a deployed position.

Another embodiment is a method of moving a ramp assembly relative to a floor of a motorized vehicle, the method includes providing an input to a main controller to move a ramp platform; moving the ramp platform to a deployed position in which the ramp platform is positioned at least partially outside the motorized vehicle using wireless communication between the main controller that is not located on the ramp platform and a secondary controller located on the ramp platform; moving the ramp platform to a stowed position in which the ramp platform is positioned inside the motorized vehicle using wireless communication between the main controller and the secondary controller; and charging a battery to the secondary controller, through a receiving inductive charger and a transmitting inductive charger, when the ramp platform is in a stowed position when the battery is not fully charged.

In one embodiment, the deploying and stowing the ramp platform aspect of the method includes: sensing whether a thing is on the ramp platform before or during the deployment of the ramp platform; and sensing whether the ramp platform encounters an obstacle before the ramp platform reaches full deployment. In an example of this embodiment, the deploying and stowing the ramp platform aspect of the method may include: sensing the slope of the ramp platform; and sensing the acceleration of the ramp platform during deployment. The deploying and stowing the ramp platform aspect of the method may further include moving the ramp platform in the opposite direction of travel for one to three inches if a sensor senses that an obstacle was encountered while deploying or stowing the ramp platform.

### BRIEF DESCRIPTION OF DRAWINGS

The above-mentioned aspects of the present disclosure and the manner of obtaining them will become more apparent and the disclosure itself will be better understood by reference to the following description of the embodiments of the disclosure, taken in conjunction with the accompanying drawings, wherein:

FIG. 1 is perspective view of a passenger vehicle including a movable ramp;

FIG. 2 is a perspective view of a ramp assembly showing a telescopic ramp in a stowed position;

FIG. 3 a partial cross-section view of the telescopic ramp assembly of FIG. 2 in a deployed position;

FIG. 4 is a side view a passenger vehicle including a moveable ramp;

FIG. 5 is a perspective side view of one embodiment of a foldable ramp assembly including a ramp platform and a ramp assist assembly with the ramp in a deployed position;

FIG. 6 is a side view of the foldable ramp assembly in a stowed position;

FIG. 7A is a perspective view of a telescopic ramp in a stowed position;

FIG. 7B is a perspective view of a telescopic ramp in a deployed position;

FIG. 7C is an enhanced perspective view of the telescopic ramp in FIG. 7B focusing on the linkage between the ramp platform and the ramp housing when the ramp platform is deployed;

FIG. 7D is an enhanced perspective view of the telescopic ramp in FIG. 7A focusing on the linkage between the ramp platform and the ramp housing when the ramp platform is stowed;

FIG. 7E is side view of a portion of the telescopic ramp in the stowed position of FIG. 7A;

FIG. 7F is an illustration highlighting several components of the vehicle and of the ramp assembly; and

FIG. 8 is an illustration highlighting several components of the wireless communication system.

### DETAILED DESCRIPTION OF THE EMBODIMENTS

The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure.

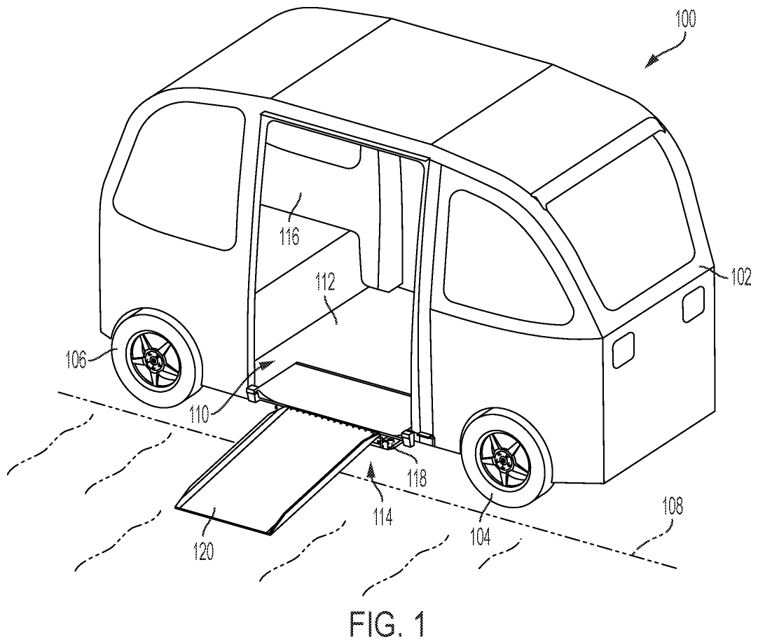

FIG. 1 illustrates a vehicle 100, commonly identified as a passenger van or bus, available from any number of United States and foreign manufacturers. The vehicle 100 may be a personal vehicle, tour bus, a double-decker bus, or any other type of vehicle. The principles and teachings of the present disclosure may be used for any type of vehicle.

In the illustrated embodiment of FIG. 1, the vehicle 100 includes a unibody construction, but other vehicles 100 having a frame on body construction, are also included in the present disclosure. Consequently, the use of vehicle 100 herein includes all types and kinds of vehicles 100 with a body on frame construction, a unibody construction, or other constructions. In addition, while the passenger van 100 is illustrated in FIG. 1, the present disclosure is directed to all passenger vehicles 100 carrying one or more passengers including, but not limited to, a bus, motor coach, sport-utility vehicle, truck, taxi, ambulance, or passenger car.

The vehicle 100 includes a frame or chassis 102 operatively coupled to front wheels 104 and rear wheels 106 that move the vehicle 100 along a ground surface 108. It should be appreciated that the vehicle 100 may be any vehicle 100, including those suitable for use with or adaptable to be used with a ramp assembly 114. A first passenger opening 110 may be located between the front wheels 104 and the rear wheels 106, and may provide access to the vehicle 100 for one or more passengers. The passenger opening 110 may be modified to increase the size of the opening 110 to provide access, for example, to a passenger seated in a wheelchair to enter and exit the vehicle 100. The vehicle 100 includes a floor 112 extending throughout the vehicle 100, to support passengers and other objects traveling in the vehicle 100. The floor 112 of the vehicle 100 may be a conventional floor 112 or it may be a modified floor 112 to accommodate the ramp assembly 114.

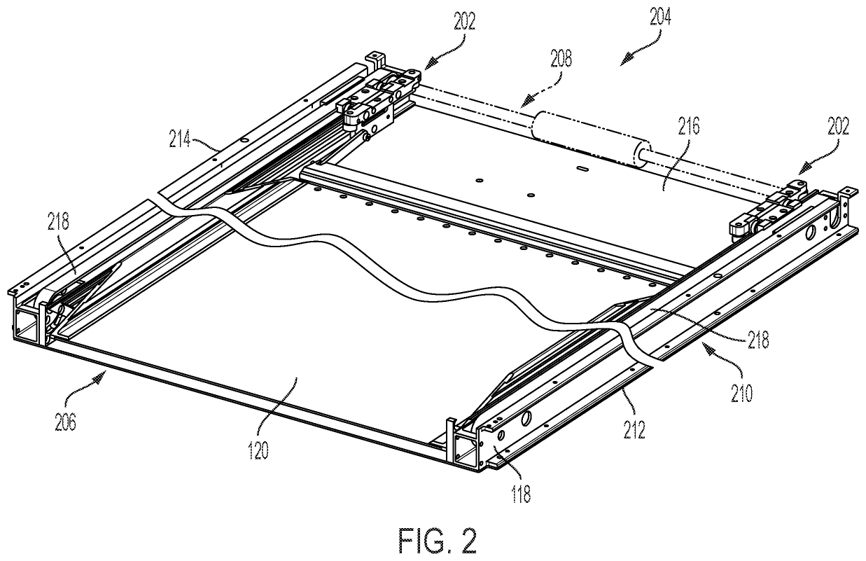

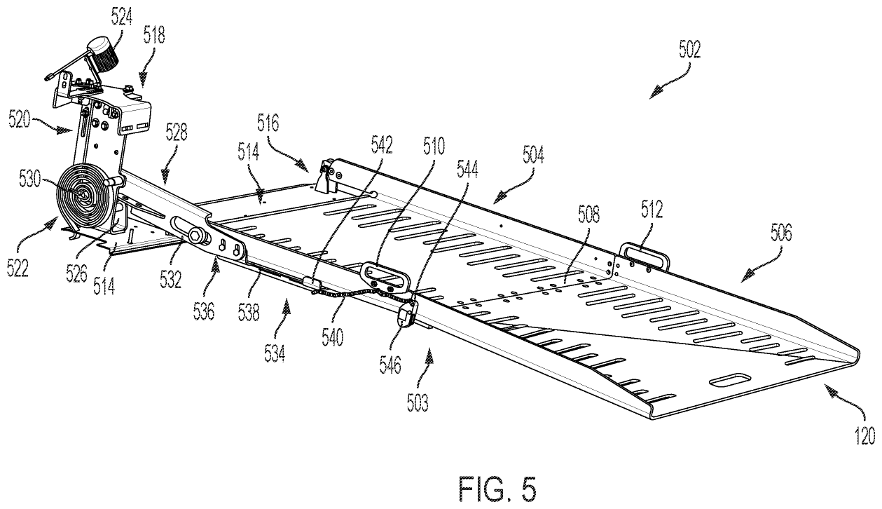

As shown in FIG. 1, the vehicle 100 may be modified to include the ramp assembly 114 that provides rolling access of a wheelchair from the ground surface 108 into an interior 116 of the vehicle 100. The ramp assembly 114 may be positioned adjacent to an opening 110 beneath the floor 112 of the vehicle 100. In one embodiment, the vehicle 100 may contain a wheelchair lift, which may assist a wheelchair user with entering and exiting the vehicle 100. In another embodiment, the vehicle 100 may have a telescopic ramp assembly 204 (See FIG. 2). In another embodiment, the vehicle 100 may have a foldable ramp assembly 502 (see FIG. 5).

In some embodiments, the middle or rear row of the seats in the vehicle 100 may be removed from the vehicle 100 to enable a passenger seated in a wheelchair to enter and exit the vehicle 100 on a ramp platform 120. Once the passenger in the wheelchair moves into the interior 116 of the vehicle 100, the wheelchair may be positioned in the middle portion of the interior 116 behind the driver and passenger seats of the front row. In other configurations, the passenger in the wheelchair may not limited to the middle row. As used herein, passenger in a wheelchair indicates that the individual is making use of a wheelchair, whether that use is temporary or permanent.

### A. Telescopic Ramp Assembly

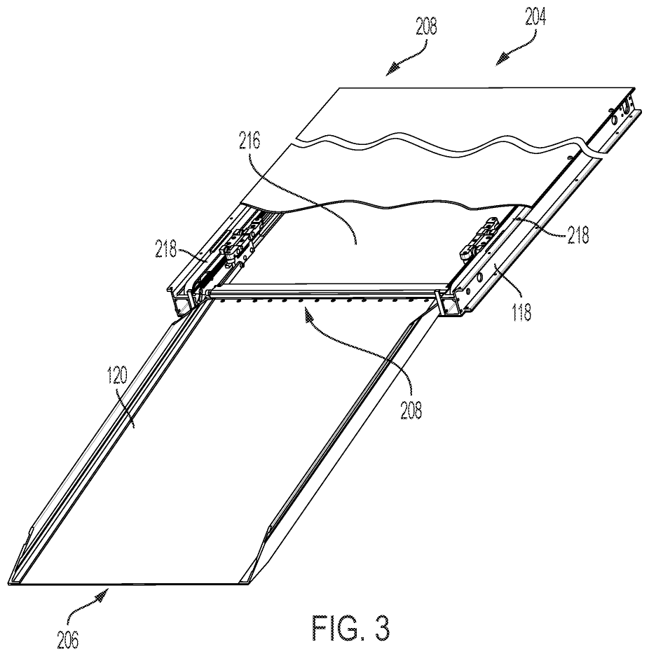

Referring to FIGS. 2-3, in one embodiment, the ramp assembly may include a telescopic ramp assembly 204 with a front end 206, a rear end 208, a ramp platform 120 defined between the front end 206 and the rear end 208, a frame 118, a linkage assembly 202 coupled between the frame 118 and the ramp platform 120, and a track system 210. The ramp platform 120 may be movable relative to the frame 118. The linkage assembly 202, for example, may allow for movement of the ramp platform 120 relative to the frame 118. The rear end 208 may be spaced longitudinally apart from the front end 206, and the track system 210 may extend longitudinally between the front end 206 and the rear end 208 of the ramp assembly 204.

The track system 210 may include a first side 212, a second side 214 and a frame floor 216 extending between the first side 212 and the second side 214. In some embodiments, the frame floor 216 may support the ramp platform 120 as the ramp platform 120 moves between a stowed position and a deployed position. In some embodiments, when the ramp platform 120 is in the stowed position, the floor 112 of the vehicle 100 may be modified so the rear end 208, the first side 212, and the second side 214 are below the floor 112 of the vehicle 100. In other embodiments, the floor 112 of the vehicle 100 may define an opening or compartment which at least partially maintains the telescopic ramp assembly 204.

In FIG. 3, one embodiment of the ramp assembly 204 is shown in the deployed position. In several embodiments, when the telescopic ramp assembly 204 is in the deployed position, the ramp platform 120 may be positioned at least partially outside the vehicle 100. In the deployed position, a rear end 208 of the ramp 120 may be positioned at, slightly above, or slightly below the vehicle's floor 112, while a front end 206 of the ramp platform 120 may be positioned on or slightly above the ground surface 108. The ground surface may be a roadway, sidewalk, parking lot, garage, grass, or any other surface. In the deployed position, the front end 206 of the ramp platform 120 may be on the ground 108, and the rear end 208 of the ramp platform 120 may be adjacent to the floor 112 of the vehicle 100. In another embodiment, the front end 206 of the ramp platform 120 may be less than a few inches above the ground 108 and the rear end 208 of the ramp platform 120 may be less than a few inches above or below the vehicle floor 112. In another embodiment, the front end 206 of the ramp platform 120 may be less than one inch above the ground 108 and the rear end 208 of the ramp platform 120 may be less than one inch above or one inch below the vehicle floor 112. In another embodiment, the front end 206 of the ramp platform 120 may be less than one half-inch above the ground 108 and the rear end 208 of the ramp platform 120 may be less than one half-inch above or one half-inch below the vehicle floor 112. In another embodiment, the front end 206 of the ramp platform 120 may be less than one quarter-inch above the ground 108 and the rear end 208 of the ramp platform 120 may be less than one quarter-inch above or one quarter-inch below the vehicle floor 112. In another embodiment, the front end 206 of the ramp platform 120 may be on the ground 108 and the rear end 208 of the ramp platform 120 may be flush with respect to the vehicle floor 112.

It is to be understood that in the illustrative embodiment of the telescopic ramp assembly 204, the first side 212 and the second side 214 of the track system 210 may be similar to one another and may be otherwise identical such that the description of the track system 210 to follow may apply equally to both the first side 212 and the second side 214 of the track system 210.

In one embodiment of the telescopic ramp assembly 204, the track system 210 may include a pair of wheels (not pictured) and an endless member such as a conveyer belt 218. The pair of wheels may be spaced longitudinally apart from one another, and the conveyer belt 218 may surround the pair of wheels. The pair of wheels may be positioned in a fixed location relative to the frame 118, and rotation of the pair of wheels may drive the conveyer belt 218 around the pair of wheels in a clockwise or counter-clockwise direction. In one embodiment, the pair of wheels may be a pair of toothed wheels and the conveyer belt 218 may be a toothed belt. Engagement between teeth of the wheels and teeth of the belt 218 may allow the pair of wheels to drive rotation of the conveyer belt 218. It should be appreciated that in other embodiments the belt 218 and wheels may be replaced with any suitable drive mechanism for advancing a drive block.

As suggested above, the linkage assembly 202 may be coupled to the frame 118 and the ramp platform 120 to facilitate movement of the ramp platform 120 relative to the frame 118. As such, the linkage assembly 202 may include a plurality of rollers (not pictured) configured to translate along the frame 118, pivot relative to the frame 118, or facilitate rotation of other components of the telescopic ramp assembly 204 relative to the frame 118.

### B. Foldable Ramp Assembly

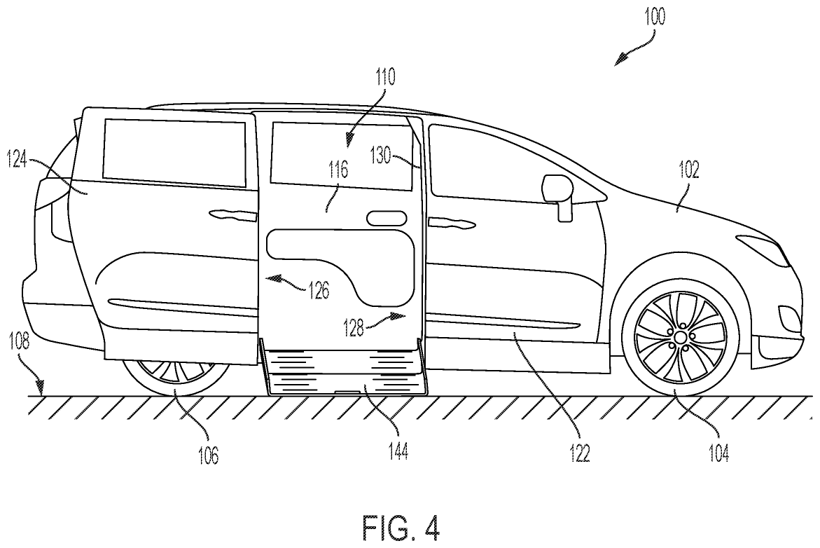

In another embodiment, the ramp assembly 114 may be a foldable ramp assembly 502, as illustrated in FIGS. 4-6. In FIG. 4, the vehicle 100 includes a frame 102 or chassis operatively coupled to front wheels 104 and rear wheels 106. A first passenger side door 122 may be located between the front wheels 104 and rear wheels 106 and provides access to a passenger for sitting in a front seat of the vehicle 100 adjacent to the driver.

The vehicle 100 of FIG. 4 may include a second passenger side door 124 coupled to the frame 102 through a sliding mechanism with tracks. While the illustrative embodiment displays a sliding door, any door known in the art may be used as the second passenger side door 124. In the illustrative embodiment, the sliding mechanism may slide along the tracks to adjust the size of the passenger opening 110 to provide access to the interior 116 of the vehicle 100. The opening 110 may be widened to provide improved access to a passenger seated in a wheelchair. The opening 110 may be defined on the sides thereof by an edge 128 of a B-pillar 130 and an edge 126 of the second passenger side door 124. In one embodiment, the vehicle 100 may be modified to include the foldable ramp assembly 502 (see FIG. 5) which may provide rolling access for a wheelchair from a ground surface 108 into the interior 116 of the vehicle 100. Similar to the telescopic ramp assembly 204 described above, the foldable ramp assembly 502 may be installed at the passenger opening 110 and may be movable between the interior 116 and exterior of the vehicle 100 to provide wheelchair access.

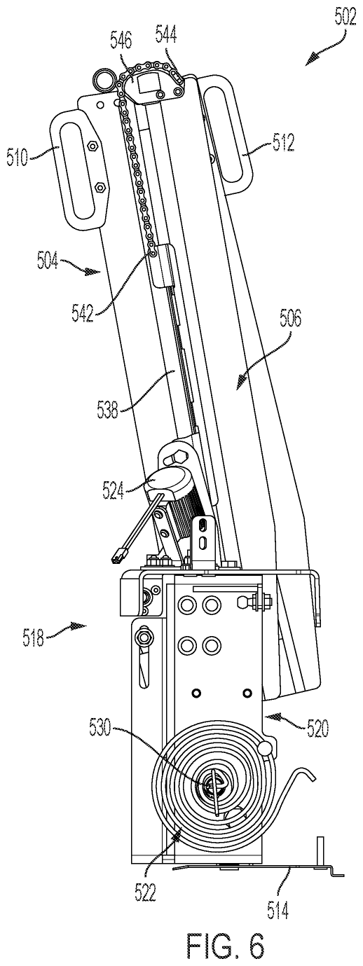

FIG. 5 illustrates a perspective view of one embodiment of the foldable ramp assembly 502 in a deployed position, and FIG. 6 illustrates a side view of this embodiment of the foldable ramp assembly 502 in a stowed positon. This foldable ramp assembly 502 may include a ramp platform 120 partially formed by a first ramp plate 504 and a second ramp plate 506. The second ramp plate 506 may be rotatably coupled to the first ramp plate 504 at a hinge 508. A first handle 510 and a second handle 512 may be coupled to the first or second ramp plate 504, 506. The handles 510, 512 may provide handholds to assist an individual in moving the foldable ramp assembly 502 between the stowed position (see FIG. 6) and the deployed position (see FIG. 5).

A floor plate 514 may be connected to a floor 112 of the vehicle 100 at the passenger opening 110. A first standoff 516 may be supported at and extend from one end of the floor plate 514 to rotatably support the first ramp plate 504 at one side. A ramp assist assembly 518 may be supported at and extend from another end of the floor plate 514. The ramp assist assembly 518 may include a support structure 520 that may support a clock spring 522 and a ramp assist assembly light 524. The clock spring 522 may provide an assisting force to an individual when moving the foldable ramp assembly 502 between the stowed position and the deployed position. The clock spring 522 may also provide an assisting force when moving the foldable ramp assembly 502 between the deployed position to the stowed position. The ramp assist assembly light 524 may be electrically coupled to a vehicle's electrical system and illuminate a portion of the floor plate 514 or a portion of the ramp platform 120.

The support structure 520 of the ramp assist assembly 518 may rotatably support a second side of the first ramp plate 504 at a second standoff 526. The support structure 520 may also rotatably support a ramp fold arm assembly 528. The ramp fold arm assembly 528 may be operatively connected to a spindle 530 of the clock spring 522 that may extend from the clock spring 522 through the support structure 520 and to the ramp fold arm assembly 528. The spindle 530 may be offset from a rotatable support, i.e., pivot, of the second standoff 526. In one embodiment, as the ramp platform 120 deploys, the clock spring 522 may be wound tighter, or coiled, to store energy. In this embodiment, the tightening of the clock spring 522 may provide a force opposite of the deployment to assist in the lowering of the ramp platform 120 in a controlled manner. As the ramp platform 120 retracts, the clock spring 522 may unwind to provide an assisting force in raising the ramp platform 120 from the deployed position to the stowed position.

The ramp fold arm assembly 528 may include a swing arm 532 that may be operatively connected to a link assembly 534, which may extend from a second end 536 of the swing arm 532. The link assembly 534 may include a link bar 538 coupled to a flexible link 540. In different embodiments, the flexible link 540 includes but is not limited to a chain, a cable, a belt, or a hose. A first end 542 of the flexible link 540 may be coupled to an end of the link bar 538 and a second end 544 of the flexible link 540 may be coupled to a chain link 546. The link bar 538 may be a slide mechanism configured to move, or slide, with respect to the first ramp plate 504. The link bar 538 may slide with respect to the first ramp plate 504 as the ramp moves between deployed and stowed positions. By moving with respect to the first ramp plate 504, the link bar 538 may maintain tension of the flexible link 540 when the foldable ramp platform 503 moves.

While a telescopic ramp assembly 204 and foldable ramp assembly 502 are described herein, any type of ramp assembly that assists a wheelchair user in accessing a vehicle 100 may be used in accordance with the present disclosure.

### C. Ramp Communication System

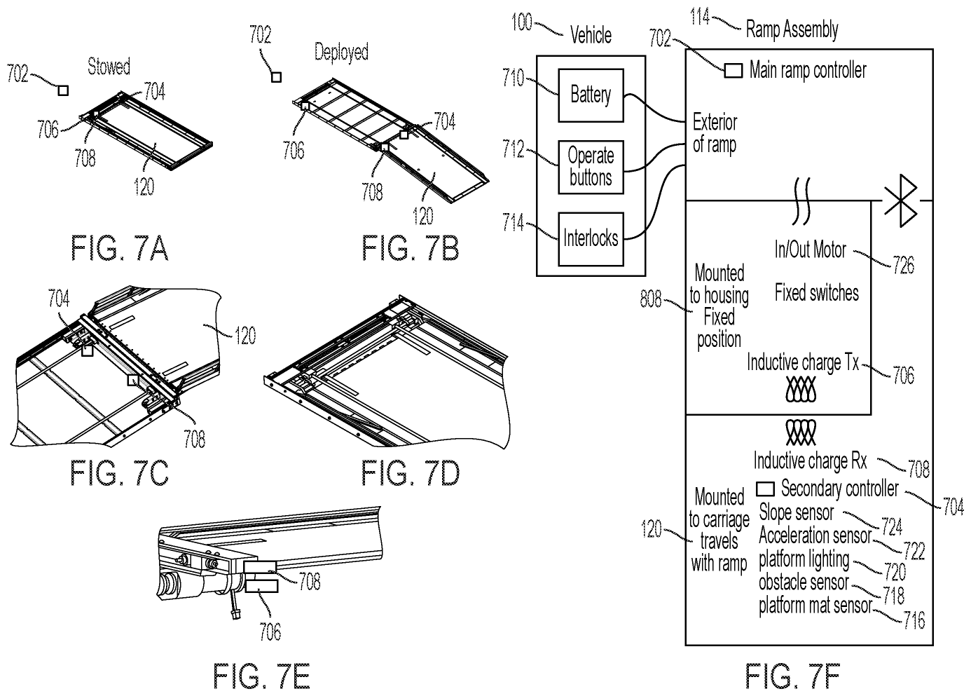

Referring now to FIGS. 7A-F and 8, a main ramp controller 702 may be coupled to the vehicle 100, a secondary controller 704 may be coupled to the ramp platform 120, a transmitting inductive charger 706 may be coupled to the vehicle 100 and to the main controller 702, and a receiving inductive charger 708 may be coupled to the ramp platform 120. The secondary controller 704 may have a battery 810 that is coupled thereto and to the receiving inductive charger 708. The main ramp controller 702 may also be coupled to a power source 710. The battery 810 may power any device coupled to the ramp platform 120.

The main ramp controller 702 may provide power to components that are coupled to the ramp platform 120, as described in further detail below. The main controller 702 may also control the logic to the ramp assembly 114. In one embodiment, the main ramp controller 702 is not coupled to the ramp platform 120. In this embodiment, the main ramp controller 702 may be located in a controller enclosure 806 within the vehicle 100, or in a glovebox of the vehicle 100. Alternatively, the controller 702 may be located on the vehicle, the ramp assembly 114, or in a remote location. The main ramp controller 702 may be coupled to a power source 710. The power source 710 may be the battery of the vehicle 100, or any other power source 710. As discussed in further detail below, when the ramp platform 120 is in the stowed position the main controller 702 may transfer power to the ramp platform 120 to provide components coupled to the ramp platform 120 with power.

In some embodiments, the secondary controller 704 may be coupled to the ramp platform 120. As described in further detail below, the secondary controller 704 may be powered by a battery 810 and the controller 704 may wirelessly communicate with the main controller 702.

Still referring to FIGS. 7A-F and 8, the transmitting inductive charger 706 may be coupled to a ramp housing 808. The ramp housing 808 may be located, for example, within the vehicle 100. In one embodiment, when the ramp platform 120 moves between stowed and deployed positions, the transmitting inductive charger 706 does not move with the ramp platform 120. The receiving inductive charger 708 and the secondary controller 704, among other components, may be coupled to the ramp platform 120. When the ramp platform 120 moves between a stowed and deployed position, the receiving inductive charger 708, the secondary controller 704, and any components coupled to the ramp platform 120 may also move with the ramp platform 120.

In one embodiment, the ramp platform 120 may be coupled to one or more platform lights 720. In another embodiment, the ramp platform 120 may be coupled to one or more sensors. In another embodiment, the ramp platform 120 may be coupled to one or more lights 720 and to one or more sensors. The one or more platform lights 720 may at least partially illuminate the ramp platform 120. The one or more lights 720 may also at least partially illuminate an area near the ramp platform 120. The one or more sensors may include a platform mat sensor 716, an obstacle detection sensor 718, an acceleration sensor 722, and/or a slope sensor 724. The obstacle detection sensor 718 may detect whether a thing is on the ramp platform 120. The sensors may also include an obstacle detection sensor 718 that detects if the ramp platform 120 encounters an obstacle, such as a curb, tree, pole, person, or other obstacle. In one embodiment, the obstacle detection sensor 718 may include logic that moves the ramp platform 120 several inches, e.g., such as one or more inches, in the opposite direction of the movement of the ramp platform 120 if the obstacle sensor 718 detects that the ramp platform 120 encountered or is about to contact an obstacle. In another embodiment, the obstacle detection sensor 718 may include logic that stops the ramp platform's 120 movement if the obstacle detection sensor 718 detects an obstacle. The sensors may also include an acceleration sensor 722. In one embodiment, the acceleration sensor 722 may be coupled to the ramp platform 120. The acceleration sensor 722 may detect the distance, speed, and/or acceleration of the ramp platform 120. In another embodiment, the acceleration sensor 722 may be coupled to an in and out motor 726 rather than the ramp platform 120. In this embodiment, the distance, speed, and/or acceleration of the ramp platform 120 may be determined from the input or output of the in and out motor 726. In this embodiment, where the acceleration sensor 722 is coupled to the in and out motor 726, the acceleration sensor 722 may not move when the ramp platform 120 moves. The sensors may also include a slope sensor 724. The slope sensor 724 may detect the slope of the ramp platform 120 as the ramp platform 120 moves. The slope sensor 724 may also detect the slope of the ramp platform 120 while the ramp platform 120 is not moving and when the ramp platform 120 is in the fully deployed position, fully stowed position, or a position between the fully deployed and fully stowed positions.

While certain sensors and components are provided above, any other sensor, switch, or component that is known in the art may be coupled to the ramp platform 120. These sensors may provide a notification if a certain indication event is sensed. In one embodiment, the platform mat sensor 716 may provide a light, noise, or any other type of notification if the sensor detects an object on the mat. The obstacle sensor 718 may also provide a light, noise, or any other type of notification if it detects that the ramp platform 120 encountered an obstacle. The acceleration sensor 722 may provide a light, noise, or any other type of notification if the sensor detects that the acceleration of the ramp is above a predetermined maximum, or below a predetermined minimum. The slope sensor 724 may provide a light, noise, or any other type of notification if the sensor detects that the slope of the ramp is above a predetermined maximum slope, or below a predetermined minimum slope. These sensors may provide the notification themselves, or they may transmit the notification to another place, such as on the dashboard of the vehicle 100, to a cell phone, or to some other device or location.

FIGS. 7A, 7D, and 7E show the ramp platform 120 in a stowed position. When the ramp platform 120 is in the stowed position, the transmitting inductive charger 706 may be at least partially aligned with the receiving inductive charger 708. When in this position the power source 710 may charge the battery 810 of the secondary controller 704. In this embodiment, the battery 810 of the secondary controller 704 may be charged from the power source 710, because the power source 710 may be coupled to the main controller 702. The main controller 702 may be coupled to the transmitting inductive charger 706 such that the transmitting inductive charger 706 may provide power to the receiving inductive charger 708, and the receiving inductive charger 708 may be coupled to the battery 810 of the secondary controller 704.

FIGS. 7B-C illustrate the ramp platform 120 in a partially or fully deployed position. When the ramp platform 120 is in the deployed position, the transmitting inductive charger 706 may be not sufficiently aligned with the receiving inductive charger 708 to transfer power to the receiving inductive charger 708. Thus, when the ramp platform 120 is in the deployed position, the transmitting inductive charger 706 may not be able to transmit a charge to the receiving inductive charger 708. In this position, the battery 810 of the secondary controller 704 may not be actively receiving power from the power source 710 because there is a break in the connection. The separation of the transmitting and receiving inductive chargers 706, 708 may cause this break in connection between the power source 710 and the battery 810 of the secondary controller 704 in the deployed position. Moreover, in the deployed position, the secondary controller 704 may be powered by the charge stored in its battery 810.

In one embodiment, when the ramp is in the deployed position, the battery 810 of the secondary controller 704 may also power the components coupled to the ramp platform 120. These components may include the platform mat sensor 716, the obstacle sensor 718, the platform lighting 720, the acceleration sensor 722, the slope sensor 724, and any other components that may be coupled to the ramp platform 120.

FIG. 7F illustrates one embodiment where a battery 710, operate buttons 712, and interlocks 714 may be electrically coupled to the vehicle 100. In this embodiment, the battery 710 may be the vehicle 100 battery which operates as the power source 710. In one embodiment, the operate buttons 712 may be located on the interior 116 of the vehicle 100. In another embodiment, the operate buttons 712 may be located near the passenger opening 110. In a further embodiment, the operate buttons 712 may be located near a driver or operator seat of the vehicle. In another embodiment, the operate buttons 712 may be located near a passenger seat. In another embodiment, the operate buttons 712 may be located on the exterior of the vehicle 100 near the passenger opening 110. In another embodiment, the operate buttons 712 may be located on the exterior of the vehicle 100 near a driver door. In other embodiments, the operate buttons 712 may be in any position on the interior 116 or the exterior of the vehicle 100. In yet another embodiment, the operate buttons 712 may be accessed through a device that is not attached to the vehicle 100. In this embodiment, the buttons 712 may be accessed through a cell phone, or any other device with the ability to communicate with the ramp assembly 114. The operate buttons 712 may operate the ramp assembly 114 and may provide an input to the main ramp controller 702 to move the ramp platform 120 between stowed and deployed positions.

The interlocks 714 illustrated in FIG. 7F may be embodied by any information shared between the vehicle 100 and the ramp platform 120. In one embodiment, the vehicle 100 may communicate with the ramp platform 120 through the main controller 702 which may be coupled to the vehicle 100, and with the secondary controller 704 which may be coupled to the ramp platform 120. As will be described in further detail, in another embodiment the main controller 702 may communicate with the secondary controller 704 through a daughter board 804.

The interlocks 714 may include communications from the ramp platform 120 to the vehicle 100. In one embodiment this communication may occur between the secondary controller 704 and the main controller 702. In some embodiments, this communication may occur between the secondary controller 704 and the main controller 702 through the daughter board 804. The secondary controller 704 may communicate to the main controller 702 that the ramp platform 120 is moving. Providing this information may allow the main controller 702 to operate a notification system, such as an audible alarm, lights, a message or another type of notification. In some embodiments, the secondary controller 704 may be a sensor disposed in communication with the main controller 702 to communicate movement or positioning of the ramp platform 120 to the main controller 702.

The secondary controller 704 may also provide information to the main controller 702 that the ramp is in the fully stowed position. In some embodiments, when the main controller 702 is notified that the ramp is in the fully stowed position, the main controller 702 may enable the second passenger side door 124 of the vehicle 100 to close. In some embodiments, when the main controller 702 is notified that the ramp is in the fully stowed position the main controller 702 may enable the vehicle 100 to shift the transmission out of park or disable a park brake function. In some embodiments, when the main controller 702 is notified that the ramp is in the fully stowed position, the main controller 702 may enable the vehicle 100 or vehicle user to perform any other type of safety mechanism.

The secondary controller 704 may communicate to the main controller 702 that the ramp platform 120 is in the fully deployed position. In some embodiments, when the main controller 702 is notified that the ramp platform 120 is in the fully deployed position, the main controller 702 may disable the second passenger side door 124 from closing. In some embodiments, when the main controller 702 is notified that the ramp platform 120 is in the fully deployed position, the main controller 702 may disable any door in the vehicle 100 from closing. In some embodiments, when the main controller 702 is notified that the ramp platform 120 is in the fully deployed position, the main controller 702 may disable the vehicle's 100 transmission from being shifted out of park. In other embodiments, the main controller 702 may be programmed to enable or disable other functions or communicate certain messages to the secondary controller 704, a dashboard, another controller, or any other source on or remote from the vehicle 100.

The secondary controller 704 may additionally communicate the slope of the ramp platform 120 to the main controller 702. In some embodiments, when the main controller 702 is notified of the slope of the ramp, this may allow for data collection by the operator and/or a third party. In some embodiments, when the main controller 702 is notified of the slope of the ramp, the main controller 702 may provide a warning to a driver, one or more passengers, or a third party if there is a condition where the ramp platform 120 exceeds predetermined slope requirements. In some embodiments, when the main controller 702 is notified of the slope of the ramp, the main controller 702 may transmit a warning to another device, and that other device may provide an audible alarm, lights, a message, or another type of notification to a driver, one or more passengers, or a third party if there is a condition where the ramp platform 120 exceeds predetermined slope requirements.

The secondary controller 704 may further communicate to the main controller 702 the cycle count of how many times the ramp platform 120 has moved between the stowed or partially stowed position to the deployed or partially deployed position. In some embodiments, providing the cycle count to the main controller 702 may allow for data collection by an operator and/or a third party. In some embodiments, the cycle count may be an indicator for periodic maintenance.

The interlocks 714 may also include communications from the vehicle 100 to the ramp platform 120. In some embodiments, the communication between the vehicle 100 and the ramp platform 120 may occur between the main controller 702 and the secondary controller 704. In some embodiments, the communication between the vehicle 100 and the ramp platform 120 may occur between the main controller 702 and the secondary controller 704 through the daughter board 804.

The main controller 702 may communicate to the secondary controller 704 that the ramp platform 120 is enabled. In one embodiment, communicating that the ramp platform is enabled to the secondary controller 704 may allow the secondary controller 704 to enable operation functions. In one embodiment, communicating that the ramp platform 120 is enabled to the secondary controller 704 may allow the secondary controller 704 to establish a wireless connection to any sensor or component of the ramp platform 120 in preparation for deployment of the ramp platform 120.

The main controller 702 may also communicate to the secondary controller 704 that the vehicle door associated with the ramp assembly 114 is open. In one embodiment, communicating that the vehicle door associated with the ramp assembly 114 is open to the secondary controller 704 may allow the secondary controller 704 to enable the function of the sensors, lights, and other components of the ramp platform 120. The main controller 702 may also provide information to the secondary controller 704 that the vehicle 100 door associated with the ramp assembly 114 is closed. This may disable the sensors and components of the ramp platform 120 from functioning. The main controller 702 may further communicate to the secondary controller 704 that the transmission of the vehicle 100 is in Park. This may enable any sensors and components of the ramp platform 120 to function. The sensors and components may include one or more platform mat sensors 716, obstacle sensors 718, platform lighting 720, acceleration sensors 722, slope sensors 724, ramp operate buttons, or any other sensors, switches, or components. In addition to the communications disclosed above, the interlocks 714 may include any communication between the secondary controller 704 and the main ramp controller 702. While communication described above was between the secondary controller 704 and the main controller 702, it is to be understood that the communication may also occur between the secondary controller 704 and the main controller 702 through the daughter board 804, as disclosed below.

The illustrative embodiment of FIG. 7F includes a vehicle 100 with a ramp assembly 114. The ramp assembly 114 may include a housing 808 mounted to the vehicle 100, and a ramp platform or carriage 120. In one embodiment, one or more components may be coupled to the ramp platform 120 and may move relative to the vehicle 100 when the ramp platform 120 moves. In this embodiment, these components may include the receiving inductive charger 708, the secondary controller 704, the slope sensor 724, the acceleration sensor 722, platform lighting 720, the obstacle sensor 718, and the platform mat sensor 716. Additional components may also be mounted to the ramp platform 120.

In one embodiment, the ramp assembly 114 may include a housing 808 which does not move relative to the vehicle 100 when the ramp platform 120 moves. In this embodiment, an in and out motor 726 and a transmitting inductive charger 706 may be mounted to the housing 808 and remain stationary relative to the vehicle 100 when the ramp platform 120 moves. In one embodiment, the ramp platform 120 may be coupled to the in and out motor 726. In this embodiment, the in and out motor 726 may move the ramp platform 120 between stowed and deployed positions. In this embodiment, the main ramp controller 702 may receive an input to stow or deploy the ramp platform 120, the main ramp controller 702 may operate the motor 726, and the motor 726 may move the ramp platform 120. In another embodiment, the motor 726 may assist a user to manually move the ramp platform 120 between stowed and deployed positions. In still another embodiment, there may not be a motor or other device to move or assist in moving the ramp platform 120.

In one embodiment, the ramp platform 120 may contain a battery 710, operate buttons 712, and interlocks 714. In this embodiment, the battery 710, operate buttons 712, and interlocks 714 may be located exterior to the ramp assembly 114. The battery 710, operate buttons 712, and interlocks 714 may be coupled to the main ramp controller 702. In this embodiment, the main ramp controller 702 may not be located on the ramp assembly 114.

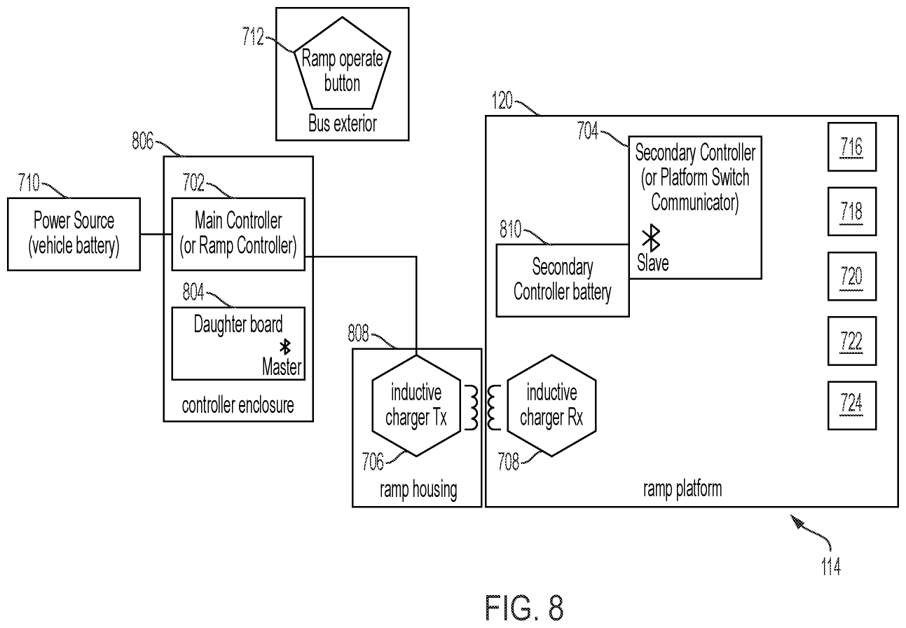

FIG. 8 illustrates one embodiment of the ramp assembly 114 where the ramp platform 120 is in the stowed position. In one embodiment, the ramp assembly 114 may include a ramp platform 120, a controller enclosure 806, and a ramp housing 808. The ramp platform 120 may be coupled to the secondary controller 704, the secondary controller battery 810, the receiving inductive charger 708, the slope sensor 724, the acceleration sensor 722, platform lighting 720, the obstacle sensor 718, and the platform mat sensor 716. Additional components, switches, and sensors may also be mounted to the ramp platform 120.

In one embodiment, the transmitting inductive charger 706 may be located at least partially in the ramp housing 808. In some embodiments, the main controller 702 and the daughter board 804 may be located at least partially within the controller enclosure 806. It should be understood that the main controller 702 and the daughter board 804 may be located anywhere inside the vehicle 100 except on a movable portion of the ramp platform 120. The main controller 702 may be coupled to the power source 710, which may be the vehicle battery 710. The main controller 702 may also be coupled to the transmitting inductive charger 706. The ramp assembly 114 may also include one or more ramp operate buttons 712. In the illustrative embodiment, the one or more ramp operate buttons 712 may be located on the exterior of the vehicle 100. In another embodiment, the one or more ramp operate buttons 712 may be located in the interior 116 of the vehicle 100. In another embodiment, the one or more ramp operate buttons 712 may be located on a moveable device. In a further embodiment, the one or more ramp buttons 712 may be part of a key fob or in an application (i.e., app) controlled on a mobile device such as a mobile or cellular phone or tablet.

In the illustrative embodiment of FIG. 8, a daughter board 804 may be coupled to the main controller 702. The daughter board 804 may be a physically separate board that is wired to the main controller 702. In this embodiment, the daughter board 804 may communicate with the secondary controller 704 and the main controller 702. When the secondary controller 704 provides information wirelessly to the daughter board 804, the daughter board 804 may provide this information to the main controller 702. When the main controller 702 provides information to the daughter board 804, the daughter board 804 may wirelessly send this information to the secondary controller 704. In addition to communicating between the main controller 702 and the secondary controller 704, the daughter board 804 may also communicate between the main controller 702 and any switches, buttons, sensors, cell phones, moveable devices, or other components or devices associated with the ramp assembly 114.

In another embodiment, the ability to communicate between the main controller 702 and the secondary controller 704 may be integrated into the main controller 702. In this embodiment, the secondary controller 704 may send information to the main controller 702, and the main controller 702 may receive the information. The main controller 702 may also send information to the secondary controller 704 and the secondary controller 704 may receive the information. In one embodiment, the components coupled to the ramp assembly 114 may provide information to the secondary controller 704, and the secondary controller 704 may wirelessly send the information to the main controller 702. In another embodiment, the components coupled to the ramp assembly 114 may provide information to the main controller 702. In another embodiment, the components coupled to the ramp assembly 114 may receive information from the main controller 702. The components coupled to the ramp assembly 114 may include, among others, one or more platform mat sensors 716, obstacle sensors 718, platform lighting 720, acceleration sensors 722, slope sensors 724, ramp operate buttons 712, or any other sensors, switches, devices, or components.

In various embodiments, the communication between the main controller 702 and the secondary controller 704 occurs wirelessly. While FIG. 8 illustrates a Bluetooth connection between the secondary controller 704 and the daughter board 804, this wireless communication may be embodied as any one or more types of communication that are capable of facilitating wireless communication between various devices. In one embodiment, the devices may communicate over a cellular network. In another embodiment, the devices my communicate with Wi-Fi. In some embodiments, the devices may communicate through radio-frequency identification (RFID). In one embodiment, the devices may communicate through Global System for Mobile Communications (GSM). In other embodiments, the devices may communicate with infrared technology. In another embodiment, the devices may communicate with GPS. In yet another embodiment, the devices may communicate through radio frequency.

Still referring to the stowed ramp assembly 114 configuration of FIG. 8, the inductive receiving charger 708 may be coupled to the ramp platform 120. Additionally the secondary controller 704 may be coupled to the ramp platform 120, and the secondary controller 704 may be coupled to the secondary controller battery 810. When the ramp assembly 114 is in the stowed position, as illustrated in FIG. 8, the receiving inductive charger 708 may be in close proximity to the transmitting inductive charger 706. In this configuration, the power source 710 may provide a charge to the battery 810 of the secondary controller 704. The battery 810 of the secondary controller 704 may charge because the power source 710 may be coupled to the main controller 702, which may be coupled to the transmitting inductive charger 706. When the transmitting inductive charger 706 is in close proximity to the receiving inductive charger 708, electrical power may pass from the transmitting inductive charger 706 to the receiving inductive charger 708. After receiving the electrical power, the receiving inductive charger 708 may provide the power to the battery 810 of the secondary controller 704, because the battery 810 of the secondary controller 704 may be coupled to the receiving inductive charger 708.

The battery 810 of the secondary controller 704 may provide power to the secondary controller 704 and to other components coupled to the ramp platform 120. These other components may include a platform mat sensor 716, an obstacle sensor 718, platform lighting 720, an acceleration sensor 722, a slope sensor 724, or any other sensor, switch, or component. The battery 810 of the secondary controller 704 may enable components coupled to the ramp platform 120 that require power to continue to operate when the ramp platform 120 is fully deployed. As an example, the secondary controller 704 may require power to communicate with the main controller 702. The battery 810 of the secondary controller 704 may help facilitate this communication by providing power to the secondary controller 704 when the ramp platform 120 is deploying or in a fully deployed position. In one embodiment, the battery 810 of the secondary controller 704 may also provide power to the secondary controller 704 when the ramp platform 120 is in the stowed position. In another embodiment, the power source 710 may power the secondary controller 704 when the ramp platform 120 is in the stowed position.

While exemplary embodiments incorporating the principles of the present disclosure have been disclosed herein, the present disclosure is not limited to the disclosed embodiments. Instead, this application is intended to cover any variations, uses, or adaptations of the disclosure using its general principles. Further, this application is intended to cover such departures from the present disclosure as come within known or customary practice in the art to which this disclosure pertains and which fall within the limits of the appended claims.

1. A vehicle access device for use to assist a passenger to enter or exit a motorized vehicle, comprising:
a platform being moveable between a stowed position and a deployed position;
a transmitting inductive charger coupled to the vehicle; and
a receiving inductive charger coupled to the platform and moveable with the platform between the stowed position and the deployed position;
wherein, the transmitting inductive charger is electrically coupled to the receiving inductive charger when the platform is in the stowed position and is electrically decoupled from the receiving inductive charger when the platform is in the deployed position.

2. The vehicle access device of claim 1 further comprising a power storage device coupled to the platform and moveable with the platform between the stowed position and the deployed position, wherein the transmitting inductive charger is electrically coupled to the power storage device when the platform is in the stowed position and is electrically decoupled from the battery when the platform is in the deployed position.

3. The vehicle access device of claim 2, wherein the power storage device is a battery.

4. The vehicle access device of claim 2 further comprising at least one accessory coupled to the platform and moveable with the platform between the stowed position and the deployed position, wherein the power storage device powers the at least one accessory at least when the platform is in the deployed position.

5. The vehicle access device of claim 4, wherein the at least one accessory is selected from a group including a controller, a slope sensor, an acceleration sensor, a light, an obstacle sensor, and a platform mat sensor.

6. The vehicle access device of claim 4, wherein the at least one accessory includes a controller and at least one from a group including a slope sensor, an acceleration sensor, a light, an obstacle sensor, and a platform mat sensor.

7. The vehicle access device of claim 2 further comprising:
a first controller configured to control movement of the platform between the stowed position and the deployed position; and,
a second controller coupled to the platform and moveable with the platform between the stowed position and the deployed position, the second controller configured to communicate with the first controller.

8. The vehicle access device of claim 7, wherein the power storage device powers the second controller at least when the platform is in the deployed position.

9. The vehicle access device of claim 7, wherein the second controller is configured to receive a first signal from at least one accessory and to transmit a second signal to the first controller, wherein the second signal is indicative of the first signal.

10. The vehicle access device of claim 7, wherein:
the first controller is located on a fixed portion of the vehicle access device or on the vehicle; and,
the second controller moves with the platform and relative to the first controller between the stowed position and deployed position.

11. The vehicle access device of claim 7, further comprising a power source electrically coupled to the transmitting inductive charger, wherein the transmitting inductive charger receives electrical power from the power source.

12. The vehicle access device of claim 11, wherein the power source is electrically coupled to the first controller and the transmitting inductive charger receives electrical power from the power source through the first controller.

13. The vehicle access device of claim 7, further comprising a daughter board coupled to the first controller, wherein the daughter board provides an input to and receives an input from the first controller; and,
further wherein, the daughter board wirelessly provides input to and receives input from the secondary controller.

14. The vehicle access device of claim 5 wherein the at least one accessory comprises the light for at least partially illuminating the platform.

15. The vehicle access device of claim 5 wherein the at least one accessory comprises the obstacle detection sensor.

16. The vehicle access device of claim 15 configured to either stop movement of the platform or reverse a direction of movement of the platform when the obstacle detection sensor detects an obstacle.

17. The vehicle access device of claim 5, wherein the at least one accessory comprises the acceleration sensor.

18. The vehicle access device of claim 17, wherein the acceleration sensor is configured to detect a distance, a speed, and an acceleration of the platform.

19. The vehicle access device of claim 5, wherein the at least one accessory comprises the slope sensor.

20. The vehicle access device of claim 19 configured to generate a signal if the slope sensor detects that the platform is above a maximum slope and/or below a minimum slope.
